(19) United States
(12) Patent Application Publication
(10) Pub. No.: US 2025/0115229 A1
(43) Pub. Date: Apr. 10, 2025

(54) BRAKE SYSTEM STRUCTURE AND VEHICLE COMPRISING A BRAKE SYSTEM STRUCTURE

(71) Applicants: Volkswagen Aktiengesellschaft, Wolfsburg (DE); Audi AG, Ingolstadt (DE)

(72) Inventors: Arne Bartels, Wolfsburg (DE); Frank Bärecke, Wolfsburg (DE); Hauke Christian Schlimme, Braunschweig (DE); Kilian Förster, Beilgries (DE); Tobias Brok, Kösching (DE); Roger Ziegler, Neuburg (DE); Michael Sagefka, Kösching (DE); Martin Stolorz, Hannover (DE)

(21) Appl. No.: 18/839,120

(22) PCT Filed: Feb. 16, 2023
(86) PCT No.: PCT/EP2023/053890

§ 371 Date: Aug. 16, 2024

(30) Foreign Application Priority Data
Feb. 17, 2022 (DE) 10 2022 103 806.8

(51) Int. Cl. B60T 17/22

(52) U.S. Cl. CPC B60T 17/221; B60T 2270/402; B60T 2270/404; B60T 2270/413

(57) ABSTRACT

A brake system structure for a vehicle, preferably a brake-by-wire system, in which detection devices and conversion devices for a brake request are mechanically decoupled from one another. The brake system structure includes: a first brake system for providing a brake function, the first brake system being configured to be autonomous and having a first power supply; a second brake system for providing a first fallback level for the brake function, the second brake system being configured to be autonomous and having a second power supply; and a third brake system for providing a second fallback level for the brake function, in particular by regenerative deceleration. A third power supply is provided at least for the first brake system.

The invention relates to a brake system structure for a vehicle, in particular a brake-by-wire system, in which in particular detection devices and implementation devices for a braking request are mechanically decoupled from one another. Furthermore, the invention relates to a vehicle comprising a corresponding brake system structure.

Brake-by-wire systems are known in principle. Brake-by-wire systems can provide multiple advantages both for conventional vehicles and for vehicles driving in an automated (level 4 according to SAE definition) to autonomous (level 5 according to SAE definition) manner.

For vehicles driving in an automated manner, brake-by-wire systems can enable the foot lever mechanism to be folded up and/or retracted. In this way, more space is created for activities for the driver, who becomes a passenger during the fully automated journey, such as sleeping, reading newspapers, surfing the Internet, etc. Moreover, the mechanical decoupling between brake pedal and brake actuator avoids undesired incorrect operation during the fully automatic journey: even if the brake pedal were not retracted, an inadvertent touch of the brake pedal during the fully automated journey (driver is sleeping at this time, for example) does not result in an undesired vehicle reaction. No driver is provided in autonomous vehicles, so that a brake-by-wire system is absolutely necessary in this case.

For conventional vehicles, entry and exit can be facilitated by brake-by-wire systems due to the folding up and/or retraction of the foot lever mechanism. The braking behavior can be adapted individually to the driver and personalized. Due to electronic adjustability of the brake characteristic curve (braking torque as a function of pedal travel and/or pedal force), it can be changed so that the driver perceives the braking behavior as softer or harder, sporty or comfortable, direct or damped. These settings can be transferred individually for the driver from vehicle to vehicle.

Advantages with regard to environmental protection are also conceivable. Due to the enlargement of the clearance between the brake disk and the brake lining, residual braking torques can be reduced. This enables a reduction of CO2 and brake dust emissions as well as an increase of the battery-electrical range.

Furthermore, advantages with regard to safety are possible. Due to the mechanical connection via a push/pull rod between brake pedal and brake regulating system being interrupted, the pedal intrusion in case of a crash can be reduced.

Moreover, the vehicles can be designed suitably for disabled people in a simple manner. For people with a physical disability which makes operating the petals more difficult or impossible, alternative operating concepts can be offered in a series construction of by-wire braking systems without complex vehicle modifications.

Furthermore, the variant diversity can thus be reduced. A nearly uniform foot lever mechanism can be installed over all vehicle classes.

In brake-by-wire systems, the mechanical fallback level by the driver is dispensed with. In order to enable continued travel in a degraded driving mode (for example reduced speed) and/or in a limited manner (for example only for a limited time or a limited distance) in a vehicle having a brake-by-wire system after an initial fault, a fallback level can be retained.

A safety system for an electrically drivable automobile, which has three braking systems, is known from DE 10 2020 202 477 A1. The automobile is designed to be drivable in a fully automated manner and/or drivable in an autonomous manner in this case.

A brake system for a vehicle, which has a primary and a secondary brake system, is known from DE 10 2019 216 896 A1. The two brake systems are controlled independently of one another via two different controllers in this case.

Known systems have the disadvantage that after a second fault and/or after the fallback of the primary brake system and furthermore the secondary brake system, the continued travel and the safety in operation of the vehicle can no longer be guaranteed.

The object of the invention is therefore to provide an improved brake system structure for a vehicle, in particular a brake-by-wire system, in which in particular detection devices and implementation devices for a braking request are mechanically decoupled from one another. In particular, it is the object of the invention to provide such a brake system structure for a vehicle, in particular such a brake-by-wire system, which enables an increased level of safety in operation of the vehicle and furthermore provides improved customer comfort. Moreover, it is the object of the invention to provide an improved vehicle comprising a corresponding brake system structure.

The object according to the invention is achieved by: a brake system structure for a vehicle, in particular a brake-by-wire system, in which preferably detection devices and implementation devices for a braking request are mechanically decoupled from one another, having the features of the independent device claim. Furthermore, the invention relates to a corresponding vehicle having the features of the other independent device claim. Features which are described in conjunction with individual aspects and/or embodiments of the invention self-evidently also apply in conjunction with the other aspects and/or embodiments and vice versa in each case, so that reference is or can always mutually be made with respect to the disclosure of the individual aspects and/or embodiments of the invention.

The invention provides: a brake system structure, a so-called brake-by-wire system, for a vehicle, for example, a hybrid or electric vehicle, such as a vehicle driving in a fully automated (level 4 according to SAE definition) to autonomous (level 5 according to SAE definition) manner. In the brake system structure, detection devices and implementation devices for a braking request (which can come from the driver or from the vehicle, for example) can advantageously be mechanically decoupled from one another. The brake system structure comprises the following subsystems:
a first (or primary) brake system (so-called autonomous brake system) for providing a braking function,
which is designed as autonomous and/or has a first (or primary) energy supply,
a second (or secondary) brake system (so-called autonomous brake system) for providing a first fallback level for the braking function, which is designed as autonomous and/or has a second (or secondary) energy supply,
and a third brake system (at least partially indirectly and/or functionally implemented brake system) for providing a second fallback level for the braking function, for example, via an electromechanical drive system of the vehicle, for example, by generator deceleration.

The vehicle in which the brake system structure according to the invention can be used can have, for example, a traction battery, such as a high-voltage battery, which can be operated using DC voltages from approximately 60 V to approximately 1.5 kV. The vehicle can furthermore have an electric motor. Furthermore, the vehicle can have at least one central control unit. Moreover, the vehicle can have a driver-vehicle interface, for example, in the form of an interactive input and output unit, e.g., comprising a display, an acoustic output device, etc.

The vehicle in which the brake system structure according to the invention can be used can preferably be designed as a vehicle driving in a fully automated manner (level 4 according to SAE definition) or a vehicle driving in an autonomous manner (level 5 according to SAE definition).

When the driver has the vehicle control, the braking request can come from the driver, for example, by actuating an electronic brake pedal. When the vehicle has the vehicle control, the braking request comes from the vehicle.

In a vehicle driving in a fully automated manner (level 4 according to SAE definition), the driver can become a passenger or user of the vehicle. In a vehicle driving in a fully automated manner, a driver-vehicle interface can be provided. In a vehicle driving in an autonomous manner (level 5 according to SAE definition), no driver is provided. Only users are provided there. In a vehicle driving in an autonomous manner, a user-vehicle interface can be provided.

The concept of the invention is that in the brake system structure, two autonomous brake systems which are maintained redundantly are provided, which are designed as autonomous or independent and which can function independently of one another and of other functional systems of the vehicle. The first and the second autonomous brake system are supplied with electrical energy via two energy supplies independent of one another, the first and the second energy supply. The independent energy supplies can each have a high-voltage battery, for example, which can be operated using DC voltages of approximately 60 V to approximately 1.5 kV. Moreover, the independent energy supplies can each have a suitable DC/DC converter.

Each of these two brake systems can moreover have multiple subsystems, such as a braking request detection unit in each case (or detection device for detecting the braking request) and a braking request implementation unit in each case (or implementation device for implementing the braking request). The braking request can be transmitted in both autonomous brake systems from the respective detection unit to the respective implementation unit via a corresponding transmission system, such as a bus system or a data bus, for example, using a CAN or SENT protocol.

The respective braking request detection unit can be embodied as an electronic brake pedal. Actuation of the brake pedal by the driver can be detected, for example, via force and/or travel sensors or the like. Control electronics of the braking request detection unit, comprising, for example, corresponding electronics and/or software, can passively receive, actively request, and possibly evaluate the sensor data. Furthermore, the control electronics of the respective braking request detection unit can transmit the sensor data and/or the results of the evaluation via an associated transmission system to the corresponding braking request implementation unit. The respective braking request implementation unit can also have control electronics, comprising, for example, corresponding electronics and/or software. The evaluation of sensor data of the respective braking request detection unit can be carried out in the control electronics of the braking request detection unit and/or in the control electronics of the braking request implementation unit. The control electronics of the braking request detection unit and the control electronics of the braking request implementation unit can be provided as separate control electronics or as common control electronics.

At least one or each braking request implementation unit can be designed as a so-called “wet” by-wire brake system. The respective braking request implementation unit can comprise an electric motor, diverse sensors, and hydraulic valves. Brake linings, which are pressed by a hydraulic pressure against the brake disks, are located in the brake calipers of the wheels. The control electronics of the braking request implementation unit and the brake calipers are connected to one another via hydraulic lines (for hydraulic valves). The control electronics actuate the electric motor in order to generate a specific hydraulic pressure and thus a specific braking torque which corresponds to the detected braking request. The pressure at the four wheels can be set, adjusted, and/or modulated via the hydraulic valves.

At least one or each braking request implementation unit can be designed as a so-called “dry” by-wire brake system. The respective braking request implementation unit can comprise an electric motor, diverse sensors, and mechanical actuating elements. Brake linings, which are pressed via electric motors and mechanical actuating elements against the brake disks, are located in the brake calipers of the wheels. The control electronics and the brake calipers are connected to one another via energy lines (for the electric motors) and data lines (for the sensors). The control electronics actuate the electric motors in the brake calipers to generate a specific braking torque which corresponds to the braking request. The braking torque at the four wheels can be modulated via a suitable actuation of the electric motors.

In addition to the first and the second autonomous brake systems, which can have a separate long-term energy supply, furthermore a short-term energy supply can be provided. The third brake system uses the electric motor operated as a generator and the control unit of the electric motor. The electric motor is connected directly to the high-voltage battery, in particular the traction battery. The high-voltage battery, in particular the traction battery, feeds the first energy supply and the second energy supply. The control unit of the electric motor is connected to the first energy supply and to the short-term energy supply. The short-term energy supply can represent a part of the third brake system. The respective long-term energy supply can take place, for example, via a DC/DC converter, which can be connected to a corresponding high-voltage battery. The short-term energy supply can take place, for example, via a low-voltage battery and/or a supercapacitor, so-called ultra cap, or the like. The operating voltage of the low-voltage battery can be in the range between 12 V and 14 V.

If a so-called “wet” by-wire brake system is used, this brake system equipped with hydraulic valves can advantageously be connected to the short-term energy supply. Fundamental braking functions such as braking the vehicle to a standstill, and safety-relevant brake regulating functions, such as ABS and ESC, can then be maintained, at least for a short time, even in the event of simultaneous failure of the primary and secondary long-term energy supply.

Moreover, the concept of the invention is that the third brake system can be provided at least partially as an indirect or dependent and/or functionally implemented or indirect braking system (or deceleration system) for providing a second fallback level for the braking function, for example, via a further functionally-essential system of the vehicle, such as an electromechanical drive system, for example, by generator deceleration. An electric motor of the electromechanical drive system which is operated in a generator mode for the generator deceleration, acts in this case as a third braking request implementation unit (or implementation device for implementing the braking request). At least one high-voltage battery, in particular a traction battery, and possibly at least one further auxiliary battery of the vehicle can be charged via the electric motor in the generator mode for the generator deceleration.

The third brake system can advantageously comprise a third braking request detection unit. The braking request detection can take place, for example, via a button of an electronic parking brake. The button can be connected via a signal line directly to the electronics of the primary and secondary braking request implementation unit (i.e., no data bus). The third braking request detection unit can supply the results of the detection to the first and/or the second autonomous brake system.

The brake system structure can have a separate control unit, which can have a communication connection to a central control unit of the vehicle. Moreover, the brake system structure can have a control unit which can be integrated in the central control unit of the vehicle as software and/or hardware.

Since the subsystems have multiple components, the failure of one of these components can result in the failure of the respective subsystem. For example, a failure of electronics, a sensor, or software can result in the failure of the primary or secondary braking request detection unit. For example, a failure of electronics, a sensor, software, or an electric motor can result in a failure of the primary or secondary braking request implementation unit. For example, a failure of an energy line, a battery, a DC/DC converter, a fuse, electronics, or software can result in the failure of the primary or the secondary energy supply. The failure of a data bus can also result in the failure of the primary or secondary brake system, such as the failure of the data bus between braking request detection unit and braking request implementation unit.

The control unit can receive diagnostic messages, “alive” signals, and/or error states both from the first and from the second autonomous brake system and from the third indirect brake system and also from the first and the second energy supply and from the third energy supply, for example, via a suitable transmission system, such as a bus system or a data bus, for example, using a CAN or SENT protocol, for example, via CAN bus, and/or a wireless transmission, for example, a radio transmission. The control unit can receive the operating parameters, such as the state of charge and the temperature, from the traction battery, for example, via a suitable transmission system, such as a bus system or a data bus, for example, using a CAN or SENT protocol, for example, via CAN bus, and/or a wireless transmission, for example, a radio transmission.

The control unit can decide on the basis of these input signals (diagnostic messages and/or error states and/or operating parameters) whether a generator deceleration is possible at all, to what extent, and/or to a standstill. Moreover, the control unit can decide whether further travel is possible after a first or second fault in the respective brake systems and/or in the energy supplies. In addition, the control unit can decide whether automatic braking and/or forced braking have to be requested and/or whether the automatic braking and/or forced braking are to take place by generator with the aid of the electric motor and/or via the first braking request implementation unit and/or via the second braking request implementation unit with the aid of the brake calipers.

The control unit can request from a control unit of the electric motor that it carry out a generator deceleration. The control unit can request a deceleration with the aid of the brake calipers from the first braking request implementation unit and/or from the second braking request implementation unit. Moreover, the control unit can actuate the driver-vehicle interface in order to inform and/or to warn the driver about the faults and/or to output a proposal for the further operation of the vehicle, such as finding a repair shop. In addition, the control unit can inform the driver about the remaining travel distance and/or about the remaining travel time.

The control unit and the control unit of the electric motor can be provided as a common unit or as two separate control units.

Several cases of fault are described as examples hereinafter, from which the advantages of the brake system structure according to the invention after a single fault in one of the brake systems are apparent. The advantages are in particular that further travel of the vehicle can be ensured. The further travel of the vehicle after a single fault is possible because two possibilities are still always provided after a single fault in order to still be able to operate the vehicle.
A relevant case of fault is the failure of the primary or secondary braking request detection unit. In this case of fault, the redundant detection of the braking request via the remaining secondary or primary braking request detection unit, and via the third braking request detection unit (such as a button of an electronic parking brake) is still ensured. The vehicle can travel further, at least to a limited extent, for example, for a specific time and/or for a specific distance, possibly at limited speed. The driver can be informed about this via the driver-vehicle interface.
A further relevant case of fault is the failure of the primary or secondary braking request implementation unit when a generator deceleration is possible at the same time. The control unit recognizes whether a generator deceleration is possible on the basis of operating parameters, such as state of charge and temperature, of the high-voltage battery, in particular the traction battery. In this case of fault, the redundant implementation of the braking request via the remaining secondary or primary braking request implementation unit, and via the generator deceleration, is still ensured. The vehicle can travel further, at least to a limited extent, for example, for a specific time and/or for a specific distance, possibly at limited speed. The driver can be informed about this via the driver-vehicle interface.
A further relevant case of fault is the failure of the first or second energy supply for the first or the second brake system. Upon failure of the first energy supply, the energy supply of the first brake system is still ensured for a short time via the third energy supply and the energy supply of the secondary brake system is still ensured via the second energy supply. Upon failure of the second long-term energy supply, the energy supply of the first brake system is still ensured via the first long-term energy supply and for a short time via the third energy supply. The vehicle can travel further, at least to a limited extent, for example, for a specific time and/or for a specific distance, possibly at limited speed. The driver can be informed about this via the driver-vehicle interface.

Several cases of fault are described as examples hereinafter, from which the advantages of the brake system structure according to the invention after a single fault or a double fault in one of the brake systems are apparent. The advantages are in particular that the vehicle can be decelerated by the automatic braking into a safe state, possibly transferred to a standstill, after a double fault. The automatic braking after a double fault is possible because at least one possibility is still provided after a double fault in order to decelerate the vehicle automatically and/or on the basis of the braking request.
A relevant case of fault is the simultaneous failure of the first and the second brake system. In this case of fault, the control unit requests automatic braking or possibly forced braking via generator deceleration from the control unit of the electric motor, for example, after a short time, such as 1 minute. The control unit of the electric motor then actuates the electric motor so that it is transferred into generator operation and decelerates regeneratively, advantageously in consideration of the state of charge and/or the temperature of the high-voltage battery, in particular the traction battery. The vehicle can thus be decelerated, advantageously and/or if possible to a standstill, and the high-voltage battery, in particular the traction battery, and possibly at least one further auxiliary battery of the vehicle are charged. The driver can be informed and/or warned about this via the driver-vehicle interface.
A further relevant case of fault is the simultaneous failure of the first and the second energy supply for the first and the second brake system. The energy supply of the control unit and the first brake system is ensured in this case of fault for a short time by the third energy supply. In this case of fault, the control unit requests immediate braking and/or forced braking to a standstill from the first brake system. The driver can be informed and/or warned about this via the driver-vehicle interface.
A relevant case of fault is the failure of either the primary or the secondary braking request implementation unit when a generator deceleration is not possible at the same time. The control unit recognizes whether a generator deceleration is possible on the basis of operating parameters, such as state of charge and temperature, of the high-voltage battery, in particular the traction battery. Possible causes of preventing a generator deceleration are, for example:
A fully charged high-voltage battery, in particular traction battery. The high-voltage battery, in particular the traction battery, cannot absorb energy, which prevents charging of the high-voltage battery by regenerative deceleration. This case can occur, for example, during longer downhill drives when the high-voltage battery, in particular the traction battery, is fully charged to 100% via regeneration. In contrast, when charging at the charging column the high-voltage battery, in particular the traction battery, is usually not fully charged to 100% in order to protect the high-voltage battery.
Very low temperature of the high-voltage battery, in particular the traction battery (for example, −30° C.). Independently of the state of charge of the high-voltage battery, in particular the traction battery, it cannot absorb electric power at very low temperatures, which prevents charging of the high-voltage battery, in particular the traction battery, by regenerative deceleration.

In this case of fault, the control unit requests automatic braking and/or forced braking to a standstill from the remaining functioning brake system after a short time. The driver can be informed and/or warned about this via the driver-vehicle interface.

As already indicated above, it can be advantageous if the third brake system can be at least partially functionally implemented by a further functionally-essential system of the vehicle, in particular by an electromechanical drive system and/or an electronic parking brake. In this way, existing resources in the vehicle can be used to provide a second fallback level to provide the braking function. The first or primary brake system supplies the brake function in the normal case here. The first fallback level for providing the braking function provides the second or secondary brake system. The second fallback level provides the third (at least partially indirect) brake system functionally or indirectly via a further functionally-essential system of the vehicle.

The third brake system can advantageously be designed to provide the braking function by a generator or regenerative deceleration. In this way, an electric motor of the electromechanical drive system can advantageously be used not only for driving, but also for decelerating the vehicle. The electric motor can therefore be used as a third implementation device for implementing the braking request.

Furthermore, it can be advantageous if the third brake system can have a third detection device for detecting the braking request. In this way, the third (at least partially indirect) brake system can provide both a braking request detection (or detection device for detecting the braking request) and a braking request implementation (or implementation device for implementing the braking request). The detection device for detecting the braking request in the third brake system is the third detection device. The implementation device for implementing the braking request in the third brake system can preferably be an electric motor of an electromechanical drive system of the vehicle when the electric motor is operated in generator operation.

The third detection device can advantageously have a button of an electronic parking brake. In this way, a simply designed and advantageous detection device for detecting the braking request can be provided in the third brake system.

The third detection device can therefore be functionally implemented at least partially by a further functionally-essential system of the vehicle, in particular by an electronic parking brake, preferably a button of an electronic parking brake.

Furthermore, it can be advantageous if the third detection device can be connected for signaling via a first signal line, in particular directly, to an electronics unit of a first implementation device of the first brake system, and/or wherein the third detection device can be connected for signaling via a second signal line, in particular directly, to an electronics unit of a second implementation device of the second brake system. In this way, the third detection device can access the first and/or the second implementation device for implementing the braking request directly, advantageously without a data bus.

Furthermore, a third energy supply can be provided at least for the first brake system. The third energy supply can preferably be designed for supplying a control unit. It is conceivable here that the third energy supply can be designed as a short-term energy supply, in particular comprising a low-voltage battery and/or a supercapacitor. In the brake system structure, three energy supplies, two long-term energy supplies and one short-term energy supply, can therefore be provided in order to enable safe braking of the vehicle in the event of a single fault or even in the event of a double fault in one of the energy supplies.

As already indicated above, the first brake system or the primary brake system can be designed as autonomous and can act independently and autonomously from other systems in the vehicle. For this purpose, the first brake system can have a first detection device for detecting the braking request, a first implementation device for implementing the braking request, and/or a first transmission system for forwarding the detected braking request from the first detection device to the first implementation device. Moreover, the first brake system can have at least one control electronics unit for a first detection device, a first implementation device, and a first transmission system.

As also indicated above, the second brake system or the secondary brake system can also be designed as autonomous and can act independently and autonomously from other systems in the vehicle. For this purpose, the second brake system can have a second detection device for detecting the braking request, a second implementation device for implementing the braking request, and/or a second transmission system for forwarding the detected braking request from the second detection device to the second implementation device. Moreover, the second brake system can have at least one control electronics unit for a second detection device, a second implementation device, and a second transmission system.

The first energy supply can advantageously be designed as a long-term energy supply, for example, comprising a high-voltage battery and/or a DC/DC converter. According to a further advantage, the second energy supply can be designed as a long-term energy supply, for example, comprising a high-voltage battery and/or a DC/DC converter.

Moreover, it is conceivable that the first energy supply and/or the second energy supply can be designed to supply a control unit. In this way, the first energy supply and/or the second energy supply can be used in a function-spanning manner.

In addition, it is conceivable that the first brake system can be connected for signaling, for example, via a transmission system, such as a bus system, to a control unit, for example, to transmit diagnostic data.

In addition, it is conceivable that the first brake system is connected with respect to control, for example, via a transmission system, such as a bus system, to a control unit, for example, to execute automatic braking and/or forced braking.

However, the second brake system can also be connected for signaling, for example, via a transmission system, such as a bus system, to a control unit, for example, to transmit diagnostic data.

Even further, the second brake system can be connected with respect to control, for example, via a transmission system, such as a bus system, to a control unit, for example, to execute automatic braking and/or forced braking.

In addition, the third brake system can also be connected for signaling, for example, via a transmission system, such as a bus system, to a control unit, for example, to transmit diagnostic data.

The first energy supply can advantageously be connected for signaling, for example, via a transmission system, such as a bus system, to a control unit, for example, to transmit diagnostic data.

Furthermore, it can be advantageous that the second energy supply can be connected for signaling, for example, via a transmission system, such as a bus system, to a control unit, for example, to transmit diagnostic data.

Moreover, it can be advantageous that the third energy supply can be connected for signaling, for example, via a transmission system, such as a bus system, to a control unit, for example, to transmit diagnostic data.

As already mentioned above, a control unit can be provided in the brake system structure. The control unit can be integrated, for example, in a central control unit of the vehicle as software and/or hardware. Alternatively, it is conceivable that the control unit can be provided as a separate control unit.

The control unit is preferably designed to request, receive, and/or process
diagnostic data from the first brake system,
diagnostic data from the second brake system,
diagnostic data from the third brake system,
diagnostic data from the first energy supply,
diagnostic data from the second energy supply,
diagnostic data from the third energy supply, and/or
at least one operating parameter of a high-voltage battery, in particular
a traction battery, of the vehicle.

In this way, the control unit can decide whether the brake systems are functional, whether a fault is present, whether a double fault is present, and/or whether the high-voltage battery, in particular the traction battery, and possibly at least one further auxiliary battery of the vehicle can be charged.

Furthermore, the control unit can be designed
to actuate the first brake system and/or the second brake system to execute automatic braking and/or forced braking.

The actuation can preferably take place in dependence on diagnostic data from the first brake system, from the second brake system, from the third brake system, from the first energy supply, from the second energy supply, from the third energy supply, and/or from at least one operating parameter of a high-voltage battery, in particular the traction battery, of the vehicle.

Furthermore, the control unit can be designed
to actuate a further functionally-essential system of the vehicle, in particular an electromechanical drive system, in order to provide the braking function by a generator deceleration.

The actuation can preferably take place in dependence on diagnostic data from the first brake system, from the second brake system, from the third brake system, from the first energy supply, from the second energy supply, from the third energy supply, and/or from at least one operating parameter of a high-voltage battery, in particular a traction battery, of the vehicle.

Moreover, the control unit can be designed
to actuate a driver-vehicle interface in order to inform and/or warn a driver about faults and/or to output a suggestion for the further operation of the vehicle, such as finding a repair shop. In a vehicle driving in an autonomous manner, the driver-vehicle interface can be designated as a user-vehicle interface or a passenger-vehicle interface.

In addition, the control unit can be designed
to inform a driver about remaining travel distance and/or about remaining travel time.

The invention furthermore provides: a vehicle comprising a brake system structure which can be embodied as described above. With the aid of the vehicle according to the invention, the same advantages can be achieved as were described above in conjunction with the brake system structure according to the invention. Reference is made in the present case to the entirety of these advantages.

Furthermore, a steering system or a steer-by-wire system can be provided in the vehicle, which can have the following subsystems:
a first steering system for providing a steering function, which is designed as autonomous and/or has a first energy supply,
a second steering system for providing a first fallback level for the steering function,
which is designed as autonomous and/or has a second energy supply,
and a third steering system for providing a second fallback level for the steering function, in particular by wheel-selective braking.

The third steering system can be at least partially functionally implemented in this case a further functionally-essential system of the vehicle, in particular by the primary and/or secondary brake system and/or a driver assistance system.

The third steering system can advantageously be designed to provide the steering function by way of wheel-selective braking.

The third steering system can furthermore have a third detection device for detecting the steering request. The third detection device can have, for example, a third steering wheel angle sensor for detecting the steering request. Moreover, the third detection device can be at least partially functionally implemented by a further functionally-essential system of the vehicle, in particular by a driver assistance system, preferably a lane keeping assistant, an autopilot, etc.

The third detection device can have a third transmission system for forwarding the detected steering request to a control unit. Furthermore, a first signal line can be provided, which is designed to forward the detected steering request from the control unit to the first steering system. Moreover, a second signal line can be provided, which is designed to forward the detected steering request from the control unit to the second steering system.

The third energy supply can be used for the first steering system.

Furthermore, the invention will be described in more detail on the basis of the figure. It is to be noted here that the figure only has descriptive character and is not intended to restrict the invention in any form. In the figure:

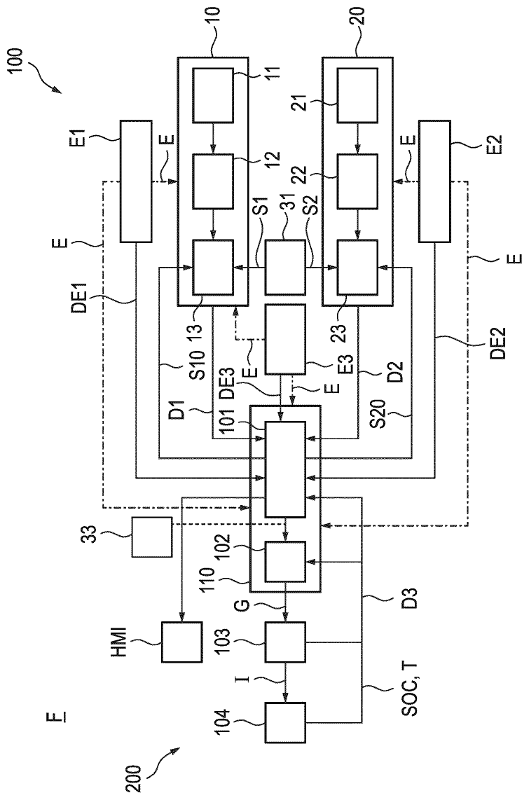

FIG. 1 shows an exemplary brake system structure in the scope of the present disclosure.

FIG. 1 shows a brake system structure 100 in the scope of the present disclosure, which can advantageously be designed in the form of a brake-by-wire system for a vehicle F, for example, a hybrid or electric vehicle. In the brake system structure 100 in the scope of the present disclosure, detection devices 11, 21, 31 and implementation devices 13, 23, 33 for a braking request (which can come from the driver or from the vehicle, for example) can be mechanically decoupled from one another.

The brake system structure 100 has the following systems 10, 20, 30:
a first or primary brake system 10,
which can also be designated as a first or primary autonomous brake system,
which is designed to provide a braking function,
and which is designed as autonomous and/or has a first or primary energy supply E1,
a second or secondary brake system 20,
which can also be designated as a second or secondary autonomous brake system,
which is designed to provide a first fallback level for the braking function,
and which is designed as autonomous and/or has a second or secondary energy supply E2,
and a third brake system 30,
which can be designed at least partially as an indirectly and/or functionally implemented brake system,
which is designed to provide a second fallback level for the braking function, for example, via an electromechanical drive system 103, 104 of the vehicle F, preferably via an electric motor 103 of the electromechanical drive system 103, 104, which can be operated in a generator mode to provide the braking function in the second fallback level, in order to enable a generator deceleration of the vehicle F.

The vehicle F can furthermore have a traction battery 104, such as a high-voltage battery, in the context of the electromechanical drive system 103, 104, which can be operated using DC voltages from approximately 60 V to approximately 1.5 kV.

The vehicle F can moreover have at least one central control unit 110.

In addition, the vehicle F can comprise a driver-vehicle interface HMI, for example, in the form of an interactive input and output unit, e.g., comprising a display, an acoustic output device, etc.

As FIG. 1 illustrates, two redundantly maintained autonomous brake systems 10, 20 are provided in the brake system structure 100, which are designed as autonomous or independent and can function independently of one another and of other functional systems of the vehicle F.

The first brake system 10 and the second brake system 20 are supplied with electrical energy E via two energy supplies E1, E2 independent of one another, as indicated in FIG. 1 with the aid of dot-dash lines. The independent energy supplies E1, E2 can each have a high-voltage battery, for example, which can be operated using DC voltages from approximately 60 V to approximately 1.5 kV. Moreover, the independent energy supplies E1, E2 can each have a suitable DC/DC converter.

Each of these two autonomous brake systems 10, 20 can moreover have multiple subsystems 11, 12, 13 and 21, 22, 23, such as a braking request detection unit or detection device 11, 21 for detecting the braking request in each case and a braking request implementation unit or implementation device 13, 23 for implementing the braking request in each case. The braking request can be transmitted in both autonomous brake systems 10, 20 from the respective detection device 11, 21 to the respective implementation device 13, 23 via a corresponding transmission system 12, 22, such as a bus system or a data bus, for example, using a CAN or SENT protocol.

The respective detection device 11, 21 can be designed as an electronic brake pedal. The actuation of the brake pedal by the driver can be detected, for example, via force and/or travel sensors or the like. A corresponding control electronics unit of the respective detection device 11, 21, comprising, for example, corresponding electronics and/or software, can passively receive, actively request, and possibly evaluate the sensor data. Furthermore, the control electronics unit of the respective detection device 11, 21 can transmit the sensor data and/or the results of the evaluation via an associated transmission system 12, 22 to the corresponding implementation device 13, 23.

The respective implementation device 13, 23 can also have a corresponding control electronics unit, comprising, for example, corresponding electronics and/or software. The evaluation of sensor data of the respective detection device 11, 21 can be carried out in the control electronics unit of the detection device 11, 21 and/or in the control electronics unit of the implementation device 13, 23. The control electronics unit of the detection device 11, 21 and the control electronics unit of the detection device 13, 23 can be provided as separate control electronics units or as a common control electronics unit.

At least one implementation device 13, 23 can be designed as a so-called “wet” by-wire brake system. The implementation device 13, 23 can have an electric motor, diverse sensors, and hydraulic valves. The brake linings in the brake calipers can be pressed in this case by a hydraulic pressure against the brake disks. A control electronics unit of the implementation device 13, 23 and the brake calipers can be connected to one another via hydraulic lines (for hydraulic valves). The control electronics unit actuates the electric motor such that a specific hydraulic pressure and a specific braking torque can be generated, which corresponds to the detected braking request.

At least one implementation device 13, 23 can be designed as a so-called “dry” by-wire brake system. The implementation device 13, 23 can comprise an electric motor, diverse sensors, and mechanical actuating elements. The brake linings in the brake calipers can be pressed against the brake disks via electric motors and mechanical actuating elements. The control electronics and the brake calipers can be connected to one another via energy lines (for the electric motors) and data lines (for the sensors). The control electronics unit actuates the electric motors such that a specific braking torque can be provided, which corresponds to the detected braking request.

The first brake system 10 and the second brake system 20 each have a separate energy supply E1, E2, in particular a long-term energy supply. The third brake system 30 can furthermore have a third energy supply E3, in particular a short-term energy supply. The respective long-term energy supply E1, E2 can have, for example, a DC/DC converter, which can be connected to a corresponding high-voltage battery. The short-term energy supply E3 can have, for example, a low-voltage battery and/or a supercapacitor, so-called ultra cap, or the like.

If a so-called “wet” by-wire brake system is used and only one of the two brake systems 10, 20 is equipped with hydraulic valves for modulating the brake pressures, the brake system equipped with hydraulic valves can advantageously be connected to the short-term energy supply E3. In this way, even in the event of simultaneous failure of the primary and secondary long-term energy supply E1, E2, fundamental braking functions such as braking the vehicle down to a standstill, and safety-relevant brake regulating functions, such as ABS and ESC, can be ensured, at least for a short time.

The invention is based on the concept that the third brake system 30 can be designed at least partially as an indirect or indirectly designed brake system, preferably as a deceleration system, for providing a second fallback level for the braking function. The third brake system 30 can functionally use a further functionally-essential system of the vehicle F, such as the electromechanical drive system 103, 104, in particular the electric motor 103 in a generator operation G, in order to provide the braking function in the second fallback level, for example, by a generator deceleration of the vehicle F. The electric motor 103 in the generator operation G acts here like a third implementation device 33 for providing the braking function in the second fallback level.

The third brake system 30 can advantageously comprise a separate, this means the third, braking request detection unit or detection device 31 for detecting the braking request (which can come from the driver, for example). The detection device 31 can have a button of an electronic parking brake. The button can be connected via a signal line directly to the electronics of the primary and secondary implementation device 13, 23.

The brake system structure 100 can have a separate control unit 101, which can have a communication connection to a central control unit 110 of the vehicle F. As indicated in FIG. 1, the brake system structure 100 can have a control unit 101, which can be integrated as software and/or hardware in the central control unit 110 of the vehicle F.

Since the subsystems of the two autonomous brake systems 10, 20 have multiple components, the failure of one of these components can result in a partial or complete failure of the brake systems 10, 20. A failure of one of the brake systems 10, 20 can be caused by a failure of an energy line, a data bus, a battery, a DC/DC converter, a fuse, software, a sensor, an actuator, a valve, an actuating element, etc.

As FIG. 1 illustrates, the control unit 101 can receive diagnostic data D1, D2, D3, DE1, DE2, DE3, “alive” signals, and/or fault states both from the first and from the second autonomous brake system 10, 20 and from the third indirect brake system 30 and also from the first and second energy supply E1, E2 as well as from the third energy supply E3, for example, via a suitable transmission system, such as a bus system or a data bus, for example, using a CAN or SENT protocol, for example, via CAN bus, and/or a wireless transmission, such as a radio transmission. The control unit 101 can receive the operating parameters, such as the state of charge SOC and the temperature T, from the high-voltage battery, in particular the traction battery 104, for example, via a suitable transmission system, such as a bus system or a data bus, for example, using a CAN or SENT protocol, for example, via CAN bus, and/or a wireless transmission, such as a radio transmission.

The control unit 101 can decide as a function of diagnostic data D1, D2, D3, DE1, DE2, DE3 and/or operating parameters SOC, T of the high-voltage battery, in particular the traction battery 104, whether a generator deceleration is possible at all, to what extent, and/or to full braking. Moreover, the control unit 101 can decide whether further travel of the vehicle F is possible after a first or second fault in the respective brake systems 10, 20, 30 and/or in the energy supplies E1, E2, E3. In addition, the control unit 101 can decide whether moderate braking and/or forced braking of the vehicle F is necessary, and/or whether automatic braking and/or forced braking is to be carried out by a generator with the aid of the electric motor 103 and/or via the first implementation device 13 and/or via the second implementation device 23 with the aid of the brake calipers.

The control unit 101 can request from a control unit 102 of the electric motor 103 that a generator deceleration be carried out. The control unit 101 can request, from the first implementation device 13 and/or from the second implementation device 23, a deceleration with the aid of the brake calipers. Moreover, the control unit 101 can actuate the driver-vehicle interface HMI to inform and/or warn the driver about the faults in the brake systems 10, 20 and/or to output a proposal for the further operation of the vehicle F, such as finding a repair shop. In addition, the control unit 101 can inform the driver about the remaining travel distance and/or about the remaining travel time.

The control unit 101 and the control unit 102 of the electric motor 103 can be provided as a common control unit, for example, in the scope of the central control unit 110 of the vehicle F, or as two separate control units.

Several cases of fault are described by way of example hereinafter, which can be addressed with the aid of the brake system structure 100 in an advantageous, comfortable, and safe manner, so that further travel of the vehicle F is ensured. After a single fault, there will always still be two possibilities in order to operate the vehicle.
A relevant case of fault is the failure of the primary or secondary detection device 11, 21. In this case of fault, the redundant detection of the braking request is still ensured via the remaining secondary or primary detection device 21, 11, and via the third detection device 31, such as a button of an electronic parking brake. The vehicle F can travel further, at least to a limited extent, for example, for a specific time and/or for a specific distance. The driver can be informed about this via the driver-vehicle interface HMI.
A further relevant case of fault is the failure of the primary or secondary implementation device 13, 23, possibly when a generator deceleration is possible at the same time. The control unit 101 recognizes whether a generator deceleration is possible on the basis of operating parameters, such as state of charge and temperature, of the high-voltage battery, in particular the traction battery 104. In this case of fault, the redundant implementation of the braking request is still ensured via the remaining secondary or primary implementation device 23, 13, and possibly via the generator deceleration. The vehicle F can travel further, at least to a limited extent, for example, for a specific time and/or for a specific distance. The driver can be informed about this via the driver-vehicle interface HMI.
A further relevant case of fault is the failure of the first or second energy supply E1, E2 for the first or the second brake system 10, 20. Upon failure of the first energy supply E1, the energy supply of the first brake system 10 is still ensured for a short time via the third energy supply E3 and the energy supply E2 of the secondary brake system 20 via the second energy supply E2. Upon failure of the second long-term energy supply E2, the energy supply of the first brake system is still ensured via the first long-term energy supply E1 and for a short time via the third energy supply E3. The vehicle F can travel further, at least to a limited extent, for example, for a specific time and/or for a specific distance. The driver can be informed about this via the driver-vehicle interface HMI.

Several single cases of fault or double cases of fault are described by way of example hereinafter, which can be addressed in an improved and safe manner with the aid of the brake system structure 100, so that after a double fault the vehicle F decelerates due to the automatic braking to a safe state, if possible can be transferred to a standstill. The automatic braking can advantageously be ensured after a double fault, since at least one possibility is still provided even after a double fault in order to decelerate the vehicle automatically and/or because of the braking request.
A relevant case of fault is the simultaneous failure of the first and the second brake systems 10, 20. In this case of fault, the control unit 101 requests automatic braking and/or forced braking via generator deceleration from the control unit 102 of the electric motor 103, for example, after a short time, such as 1 minute. The control unit 102 of the electric motor 103 then actuates the electric motor 103 in such a way that it is transferred into the generator operation G and decelerates the vehicle F by regeneration, advantageously in consideration of the state of charge SOC and/or the temperature T of the high-voltage battery, in particular the traction battery 104. The electric motor 103 generates a charging current I for the high-voltage battery, in particular the traction battery 104, which is thus charged. The driver can be informed and/or warned about this via the driver-vehicle interface HMI.
A further relevant case of fault is the simultaneous failure of the first and the second energy supply E1, E2 for the first and the second brake system 10, 20. The energy supply of the control unit 101 and of the first brake system 10 is ensured in this case of fault for a short time by the third energy supply E3. In this case of fault, the control unit 101 requests immediate braking and/or forced braking to a standstill from the first brake system 10. The driver can be informed and/or warned about this via the driver-vehicle interface HMI.
A relevant case of fault is the failure of either the primary or the secondary implementation device 13, 23, in particular if a generator deceleration is not possible at the same time. The control unit 101 recognizes whether a generator deceleration is possible on the basis of operating parameters, such as state of charge and temperature, of the high-voltage battery, in particular the traction battery 104. Possible cases when the generator deceleration is not possible are, for example:
A fully charged high-voltage battery, in particular traction battery 104. The high-voltage battery, in particular the traction battery 104, cannot absorb energy in this case. This case can occur, for example, during longer downhill drives if the high-voltage battery, in particular the traction battery 104, is fully charged to 100% via regeneration. When charging at the charging column, the traction battery 104 is usually not fully charged to 100% in order to protect the high-voltage battery.
Very low temperature T of the traction battery 104, such as T=−30° C. Independently of the state of charge SOC of the traction battery 104, electrical power cannot be absorbed at very low temperatures T.

In this case of fault the control unit 101 requests automatic braking and/or forced braking to a standstill after a short time from the remaining functioning brake system 10, 20. The driver can be informed and/or warned about this via the driver-vehicle interface HMI.

### LIST OF REFERENCE SIGNS

F vehicle
100 brake system structure
10 first brake system
11 first detection device
12 first transmission system
13 first implementation device
20 second brake system
21 second detection device
22 second transmission system
23 second implementation device
30 third brake system
31 third detection device
33 third implementation device, generator deceleration
110 central control unit
101 control unit
102 control unit
200 further functionally-essential system
103, 104 drive system
103 electric motor
104 traction battery
E electric energy
E1 first energy supply
E2 second energy supply
E3 third energy supply
G generator operation
I charging current
HMI driver-vehicle interface
S1 first signal line
S2 second signal line
S10 automatic braking and/or forced braking
S20 automatic braking and/or forced braking
D1 diagnostic data
D2 diagnostic data
D3 diagnostic data
DE1 diagnostic data
DE2 diagnostic data
DE3 diagnostic data
SOC state of charge
T temperature

1-15. (canceled)

16. A brake system structure for a vehicle, wherein detection devices and implementation devices for a braking request are mechanically decoupled from one another, the brake system structure comprising:
a first brake system for providing a braking function, said first brake system being autonomous and having a first energy supply;
a second brake system for providing a first fallback level for the braking function, said second brake system being autonomous and having a second energy supply;
a third brake system for providing a second fallback level for the braking function; and
a third energy supply provided at least for said first brake system.

17. The brake system structure according to claim 16, wherein at least one of the following is true:
said third brake system is at least partially functionally implemented by a further functionally-essential system of the vehicle, being at least one of an electromechanical drive system or an electronic parking brake;
said third brake system is designed to provide the braking function by a generator deceleration.

18. The brake system structure according to claim 16, wherein:
said third brake system has a third detection device for detecting the braking request;
said third detection device has a button of an electronic parking brake; and
said third detection device is at least partially functionally implemented by a further functionally-essential system of the vehicle.

19. The brake system structure according to claim 18, wherein the further functionally-essential system of the vehicle is an electronic parking brake triggered by a trigger button of an electronic parking brake.

20. The brake system structure according to claim 18, wherein:
said third detection device is connected for signaling via a first signal line to a first implementation device of said first brake system; and/or
said third detection device is connected for signaling via a second signal line to a second implementation device of said second brake system.

21. The brake system structure according to claim 16, wherein said third energy supply is configured to supply a control unit and/or designed as a short-term energy supply.

22. The brake system structure according to claim 16, wherein:
said first brake system has a first detection device for detecting the braking request, a first implementation device for implementing the braking request, and a first transmission system for forwarding a detected braking request from said first detection device to said first implementation device; and
said first brake system includes a control electronics unit for a first detection device, a first implementation device, and a first transmission system.

23. The brake system structure according to claim 22, wherein:
said second brake system has a second detection device for detecting the braking request, a second implementation device for implementing the braking request, and a second transmission system for forwarding a detected braking request from said second detection device to said second implementation device; and
said second brake system includes a control electronics unit for a second detection device, a second implementation device, and a second transmission system.

24. The brake system structure according to claim 16, wherein:
said first energy supply is configured as a long-term energy supply;
said second energy supply is configured as a long-term energy supply; and
at least one of said first energy supply or said second energy supply is configured to supply a control unit.

25. The brake system structure according to claim 16, wherein:
said first brake system is connected via a transmission system to a control unit for transmitting diagnostic data; and
said first brake system is connected, via the transmission system, to said control unit for executing at least one of automatic braking or forced braking.

26. The brake system structure according to claim 25, wherein the transmission system connected between said first brake system and said control unit is a communication bus system.

27. The brake system structure according to claim 25, wherein:
said second brake system is connected via the transmission system to the control unit for transmitting diagnostic data;
said second brake system is connected, via the transmission system, to the control unit for executing at least one of automatic braking or forced braking; and
said third brake system is connected to the control unit for transmitting diagnostic data.

28. The brake system structure according to claim 16, wherein:
said first energy supply is connected for signaling, via a transmission system, to a control unit for transmitting diagnostic data;
said second energy supply is connected for signaling, via the transmission system, to the control unit for transmitting diagnostic data; and
said energy supply is connected for signaling, via the transmission system, to the control unit for transmitting diagnostic data.

29. The brake system structure according to claim 16, which comprises:
a control unit integrated as software and/or hardware in a central control unit of the vehicle; and
said control unit being configured to selectively request, receive, or process one or more of the following:
diagnostic data from said first brake system;
diagnostic data from said second brake system;
diagnostic data from said third brake system;
diagnostic data from said first energy supply;
diagnostic data from said second energy supply;
diagnostic data from said third energy supply; or
at least one operating parameter of a high-voltage battery of the vehicle.

30. The brake system structure according to claim 29, wherein the high-voltage battery of the vehicle is a traction battery.

31. The brake system structure according to claim 29, wherein said control unit is configured:
to actuate at least one of said first brake system or said second brake system to execute at least one of automatic braking or forced braking as a function of diagnostic data concerning an entity selected from the group consisting of:
said first brake system, said second brake system, said third brake system, said first energy supply, said second energy supply, said third energy supply, and said at least one operating parameter of a high-voltage battery of the vehicle.

32. The brake system structure according to claim 31, wherein the high-voltage battery of the vehicle is a traction battery.

33. The brake structure according to claim 27, wherein said control unit is configured:
to actuate a further functionally-essential system of the vehicle, in order to provide the braking function by a generator deceleration;
as a function of diagnostic data from at least one of said first brake system, said second brake system, said third brake system, said first energy supply, said second energy supply, said third energy supply, or from at least one operating parameter of a traction battery of the vehicle;
to actuate a driver-vehicle interface in order to inform and/or warn a driver about faults or to output a proposal for a further operation of the vehicle; and
to inform the driver about a remaining travel distance or about a remaining travel time.

34. The brake structure according to claim 33, wherein said control unit is configured to inform the driver of a proposal to find a repair shop.

35. A vehicle, comprising a brake system structure according to claim 16.
